(19) United States
(12) Patent Application Publication
(10) Pub. No.: US 2006/0176682 A1
(43) Pub. Date: Aug. 10, 2006

(54) Power hand tool

(75) Inventors: Chien-Chun Wu, Taichung County (TW); Kim Y.C. Tsai, Taichung Hsien (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/052,780

(22) Filed: Feb. 9, 2005

(51) Int. Cl. F21V 33/00; B25B 23/18

(52) U.S. Cl. 362/119; 362/109

(57) ABSTRACT

A power hand tool includes a housing, a chuck mounted in one end of the housing for holding a tool bit, a driving device mounted in the housing and coupled to the chuck for rotating the tool bit, and a light projector mounted in the housing for projecting a plane of light toward the extending direction of the tool bit to form a line of light on a working surface to be processed by the power hand tool.

### BACKGROUND OF THE INVENTION

1. Field of the Invention

The present invention relates to a power hand tool and more particularly, to such a power hand tool, which is equipped with a laser projector that can be controlled to project a line of light on the workpiece to guide the operation of the power hand tool.

2. Description of the Related Art

When wishing to drill a number of holes on a wall or workpiece along a line or to screw screws into the wall or workpiece, the operator must draw a line on the wall or workpiece before drilling or screwing. This procedure wastes much time and labor, resulting in a low working efficiency.

### SUMMARY OF THE INVENTION

The present invention has been accomplished under the circumstances in view. It is the main object of the present invention to provide a power hand took, which greatly improves the working efficiency.

To achieve this object of the present invention, the power hand tool comprises a housing, a driving device mounted in the housing, a chuck coupled to the driving device for holding a tool bit for enabling the tool bit to be rotated by the driving device, and a light projector mounted in the housing for projecting a plane of light toward the extending direction of the tool bit to form a line of light on a working surface.

### BRIEF DESCRIPTION OF THE DRAWINGS

FIG. 1 is a schematic plain view of a power hand tool according to a preferred embodiment of the present invention.

FIG. 2 is an exploded view of a part of the power hand tool according to the preferred embodiment of the present invention.

FIG. 3 is a sectional view taken along line 3-3 of FIG. 1.

FIGS. 4-7 are schematic drawings showing the action of the present invention.

### DETAILED DESCRIPTION OF THE INVENTION

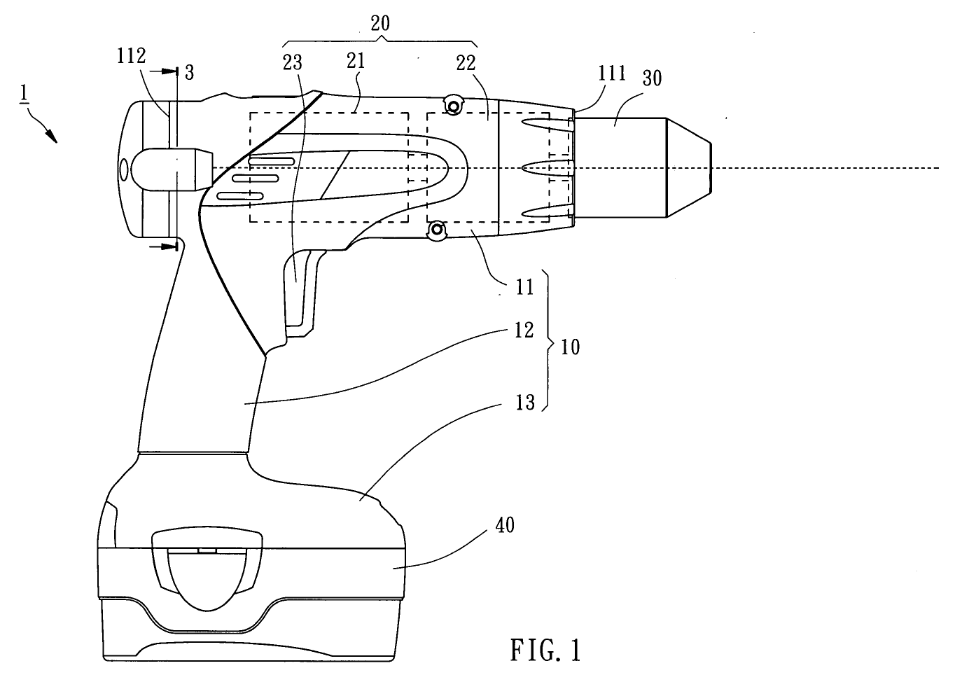

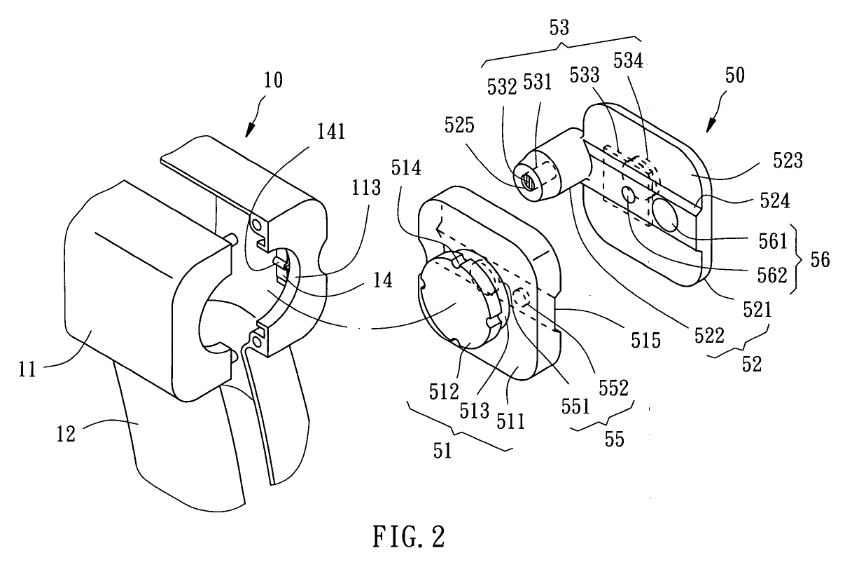

Referring to FIGS. 1-3 and 5, a power hand tool 1 in accordance with the preferred embodiment of the present invention is shown comprised of a housing 10, a driving device 20, a chuck 30, a battery pack 40, and a light projector 50.

The housing 10 is formed of a left-side cover shell and a right-side cover shell, comprising a body 11, a battery pack holder 13, and a grip 12 connected between the body 11 and the battery pack holder 13. The body 11 has a front end 111, a rear end 112, a circular opening 113 in the rear end 112, and two retaining spring strips 14 bilaterally symmetrically provided inside the body 11 adjacent to the circular opening 113. Each retaining spring strip 14 has a protruding portion 141.

The driving device 20 comprises a motor 21, a transmission gear set 22, and a control switch 23. The motor 21 and the transmission gear set 22 are mounted inside the body 11 of the housing 10. The control switch 23 is installed in the grip 12. The transmission gear set 22 is coupled to the output end of the motor 21 and adapted to reduce the revolving speed of the output of the motor 21 and increase the torque. The control switch 23 is for on/off control of the motor 21.

The chuck 30 has a part mounted inside the body 11 of the housing 10 and coupled to the output end of the transmission gear set 22 to receive rotary driving force from the transmission gear set 22, and a part extending out of the front end 111 of the body 11 of the housing 10 for holding a tool bit, for example, an auger bit.

The battery pack 40 is fastened to the battery pack holder 13 of the housing 10, and controlled by the control switch 23 to provide the necessary working voltage to the motor 21.

The light projector 50 comprises a base 51, a coupler 52, a laser module 53, a first magnet set 55, and a second magnet set 56.

The base 51 comprises a main body 511, a cylindrical positioning portion 512, and a neck 513 connected between the main body 511 and the cylindrical positioning portion 512. The neck 513 is a cylindrical member, having a diameter smaller than that of the cylindrical positioning portion 512. The cylindrical positioning portion 512 has four locating grooves 514 equiangularly spaced around the periphery thereof. The main body 511 has a coupling groove 515. The neck 513 of the base 51 is positioned in the circular opening 113 of the body 11 of the housing 10, keeping the main body 511 suspended outside the housing 10 and the cylindrical positioning portion 512 suspended inside the body 11 of the housing 10 and secured in place by the protruding portions 141 of the retaining spring strips 14.

The coupler 52 comprises a mounting plate 521 and a receptacle 522 at one side of the mounting plate 521. The mounting plate 521 comprises a coupling wall 523, and a protruding engagement portion 524 protruded from the coupling wall 523. The receptacle 522 has a light-emitting hole 525 extending in same direction as the protruding engagement portion 524.

The laser module 53 comprises a laser diode 531 mounted inside the receptacle 522, a deflecting lens 532 mounted in the light-emitting hole 525 of the receptacle 522, a circuit board 533 fixedly fastened to the coupling wall 523 and electrically connected to the laser diode 531, a battery set 534 mounted in the coupling wall 523 and electrically connected to the circuit board 533, and a press-button switch 535 mounted on the mounting plate 521 for controlling the supply of electricity from the battery set 534 to the circuit board 533. The deflecting lens 532 is adapted to deflect the laser beam of the laser diode 531 into a plane of light, which forms a line of light when projected onto a surface. The projected line of light can be a curve or straight line subject to the design of the deflecting lens 532. According to this embodiment, the projected line of light is a straight line.

The first magnet set 55 comprises a big magnet 551 and a small magnet 552 respectively embedded in the main body 511 of the base 51 and exposed with one respective end to the outside of the coupling groove 515 of the main body 511. The second magnet set 56 comprises a big magnet 561 and a small magnet 562 respectively embedded in the mounting plate 521 and exposed with one respective end to the outside of the protruding engagement portion 524 of the coupler 52. The first magnet set 55 and the second magnet set 56 are respectively arranged in the main body 511 of the base 51 and the mounting plate 521 in a reversed manner.

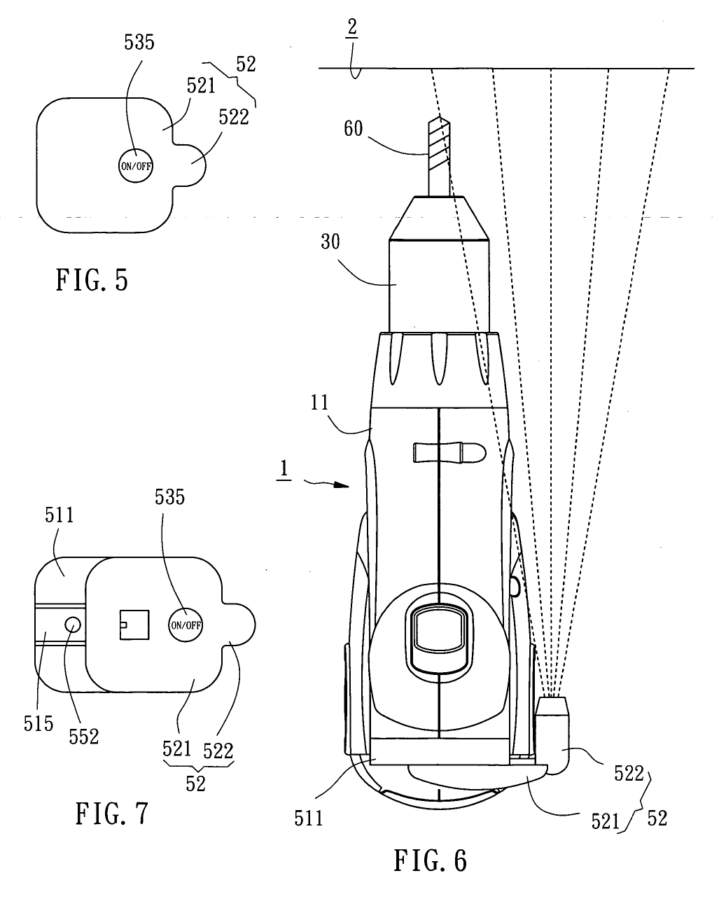

When engaged the protruding engagement portion 524 of the coupler 52 into the coupling groove 515 of the main body 511, the big and small magnets 551 and 552 of the first magnet set 55 are respectively secured to the small and big magnets 562 and 561 of the second magnet set 56 by means of magnetic attraction, and therefore the coupler 52 is secured to the base 51, keeping the receptacle 522 attached to one lateral side of the mounting plate 521 of the coupler 52. At this time, the direction of the light-emitting hole 525 is same as the extending direction of the tool bit secured to the chuck 30, as shown in FIG. 4.

Referring to FIGS. 4-7, when using the power hand tool 1 to drill a series of holes on a wall 2, the user can use the light projector 50 to guide the drilling operation, i.e., remove the coupler 52 of the light projector 50 from the base 51 and then attach the coupler 52 to the base 51 again to have the big magnet 561 of the second magnet set 56 be fastened to the big magnet 551 of the first magnet set 55 as shown in FIGS. 6 and 7. At this time, the receptacle 522 is spaced from the base 51 at a distance, preventing blocking of the laser light from the laser module 53 by the housing 10. When pressed on the press-button switch 535 of the laser module 53, the laser diode 531 of the laser module 53 is driven to emit a laser beam through the deflecting lens 532 toward the wall 2, thereby forming a line of light on the wall 2 to guide the drilling operation. Therefore, the user can easily and accurately drill a series of holes that are accurately aligned in a line. If the light projector 50 is designed to project a curve of light on the workpiece, the user can easily and accurately drill a number of holes that are accurately arranged along a curve.

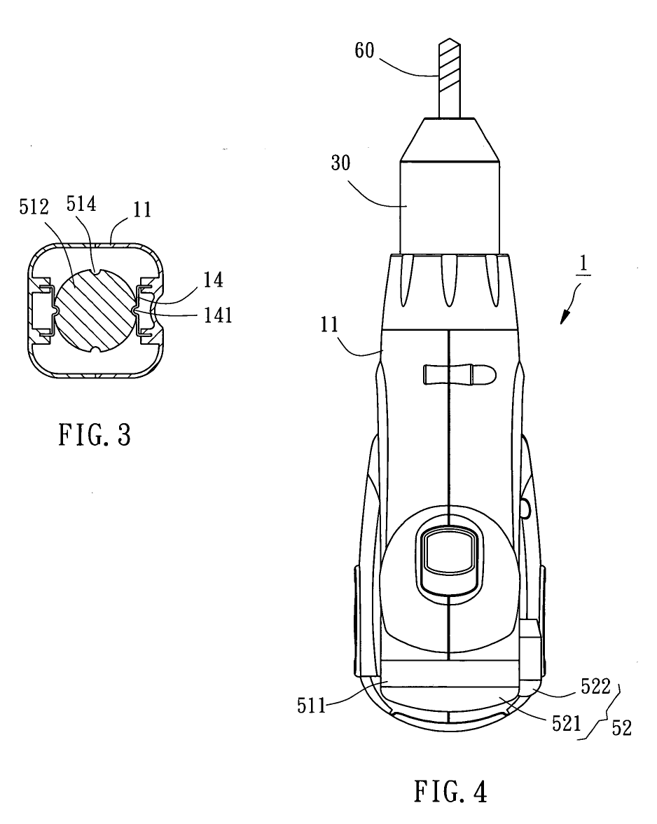

Referring to FIG. 3 again, the base 51 of the light projector 50 can be rotated on the housing 10. Because the cylindrical positioning portion 512 of the base 51 has four locating grooves 514 equiangularly spaced around the periphery thereof for receiving the protruding portions 141 of the retaining spring strips 14, the base 51 is firmly positioned in position after each rotary motion relative to the housing 10 through 90°, i.e., the laser module 53 can be set to project a vertical plane of laser light above the elevation of the housing 10, or a horizontal plane of laser light at the left or right side relative to the housing 10.

What is claimed is:

1. A power hand tool comprising:
a housing;
a driving device mounted in said housing, said driving device having a motor and a transmission gear set coupled to an output end of said motor;
a chuck coupled to said transmission gear set for holding a tool bit for enabling the tool bit to be rotated by said transmission gear set;
a battery pack detachably fastened to said housing for providing electricity to said driving device; and
a light projector mounted in said housing for projecting a line of light on a surface; wherein the light projector has a projecting direction toward an extending direction of the tool bit held by said chuck.

2. The power hand tool as claimed in claim 1, wherein said housing comprises a body for accommodating said motor and said transmission gear set of said driving device, a battery pack holder for holding said battery pack, and a grip connected between said body and said battery pack holder; said body having a front end and a rear end;
wherein said chuck has a part suspended inside said housing and coupled to an output end of said transmission gear set and a part extended out of said housing for holding the tool bit;
wherein said light projector is mounted in the rear end of said body of said housing.

3. The power hand tool as claimed in claim 2, wherein said light projector is rotatably mounted in the rear end of the body of said housing.

4. The power hand tool as claimed in claim 3, wherein said body of said housing comprises a circular opening in the rear end thereof and a retaining spring strip disposed adjacent to said circular opening for positioning said light projector to said housing, said retaining strip having a protruding portion;
wherein said light projector comprises a base having a cylindrical positioning portion suspended inside the rear end of said body of said housing and a neck extending from said cylindrical positioning portion and inserted through said circular opening of said body of said housing, said cylindrical positioning portion having four locating grooves equiangularly spaced around a periphery thereof, which are respectively engageable with the protruding portion of said retaining spring strip for enabling said retaining strip to positioning said base of said light projector to said body of said housing in such a manner that said base is rotatable relative to said body of said housing and lockable to said body of said housing in one of four angular positions that are spaced from one another at 90°.

5. The power hand tool as claimed in claim 4, wherein said light projector further comprises a coupler connectable to said base between two positions, and a laser module mounted in said coupler for projecting light.

6. The power hand tool as claimed in claim 5, wherein said base comprises a main body located outside said body of said housing and fixedly connected to one end of said neck remote from said cylindrical positioning portion, the main body of said base having a coupling groove;
wherein said coupler comprises a mounting plate and a receptacle at one side of said mounting plate, said mounting plate having a coupling wall and a protruding engagement portion protruded from said coupling wall and connectable to the coupling groove of the main body of said base, said receptacle having a light-emitting hole extending in same direction as the protruding direction of said protruding engagement portion; said laser module comprises a laser diode mounted inside said receptacle, a deflecting lens mounted in said light-emitting hole for deflecting the light of said laser diode out of said light-emitting hole into a plane of light to form the line of light on the surface, a circuit board fixedly fastened to said coupling wall and electrically connected to said laser diode, a battery set mounted in said coupling wall and electrically connected to said circuit board, and a press-button switch mounted on said mounting plate for controlling the supply of electricity from said battery set to said circuit board;
wherein said light projector further comprises a first magnet set and a second magnet set, said first magnet set having a big magnet and a small magnet respectively mounted in the coupling groove of the main body of said base, said second magnet set having a big magnet and a small magnet respectively mounted in the protruding engagement portion of said coupler for securing said coupler to said base between a first position where the big magnet and small magnet of said first magnet set are respectively fastened to the small magnet and big magnet of said second magnet set by magnetic attraction and a second position where the big magnet of said first magnet set is fastened to the big magnet of said second magnet set by magnetic attraction.
